(19) United States
(12) Patent Application Publication
(10) Pub. No.: US 2003/0061681 A1
(43) Pub. Date: Apr. 3, 2003

(54) Adjustable kingpin caster

(76) Inventor: Jack R. Plate, Clarklake, MI (US)

Correspondence Address: Duncan F. Beaman, YOUNG & BASILE, P.C., 3001 West Big Beaver Road, suite 624, Troy, MI, 48084, US

(21) Appl. No.: 09/967,558

(22) Filed: Oct. 1, 2001

(51) Int. Cl. B60B 33/04

(52) U.S. Cl. 16/19

(57) ABSTRACT

A heavy-duty caster of relatively concise configuration wherein a vertical kingpin interconnects the basic components, and the kingpin is vertically adjustable relative to its supporting structure to permit the vertical height of the caster to be readily varied.

### FIELD OF THE INVENTION

The invention pertains to heavy-duty casters utilizing a central kingpin, the kingpin being vertically adjustable to vary the caster vertical dimension.

### DESCRIPTION OF THE RELATED ART

Casters, both those rotatable about a vertical axis and the non-rotatable type, find wide usage in industrial applications, and are commonly used with material handling vehicles such as hand trucks, bins, receptacles, tables, and the like. In most instances, there is no necessity to vary the vertical dimension of the caster.

However, in some installations, vertical adjustment of the caster is highly desirable. For instance, hand operated pallet lift trucks commonly use heavy-duty casters to support relatively heavy loads. The wheels of such casters wear, and it is often necessary to adjust the vertical position of the caster to compensate for wheel wear and achieve the desired load sharing and bearing characteristics of the caster to obtain optimum results. As such small pallet lift trucks are built close to the ground and have limited vertical dimension, it is often important that the heavy-duty casters associated therewith be of a relatively concise vertical dimension, and heretofore, it has been difficult to provide a caster having vertical dimension adjustable characteristics which was of a heavy-duty type capable of supporting significant loads.

### OBJECTS OF THE INVENTION

It is an object of the invention to provide a caster having a kingpin for assembling the basic components wherein the kingpin is adjustable permitting the overall height of the caster to be varied.

Another object of the invention is to provide a heavy-duty caster having an adjustable kingpin wherein sufficient lateral support for the caster is provided even though the adjustability of the caster in a vertical direction is significant.

### SUMMARY OF THE INVENTION

A basic component of a caster in accord with the invention is the support bracket which is usually affixed to the underside of the truck, bin, table, or other item which is to be supported upon casters. The support bracket is provided with a central threaded opening into which the upper portion of the kingpin is threaded, and the lock nut threaded on the kingpin bears against the support bracket to adjust the vertical position of the kingpin relative to the support bracket.

The support bracket includes a downwardly open cavity, preferably of a cylindrical configuration, and having an open end. The cavity is preferably defined by cylindrical sidewalls.

A bearing bracket is received within the support bracket cavity and is of a peripheral configuration corresponding to the walls of the support bracket cavity wherein the bearing bracket might be considered to constitute a “piston” closely received within the support bracket cavity and axially adjustable therein. The kingpin is centrally fixed within the bearing bracket whereby adjustment of the kingpin relative to the support bracket by rotating the kingpin within the support bracket opening causes the bearing bracket to slide within the support bracket cavity to axially slide within the support bracket cavity vertically adjusting the bearing bracket with respect to the support bracket and providing lateral stability between the support bracket and bearing bracket.

The lower threaded portion of the kingpin extends below the bearing bracket and through thrust bearing components and an alignment bearing associated with a lower bearing block to which the caster arms are affixed and depend therefrom. The caster wheel is rotatably mounted upon the caster arms. Vertical adjustment of the kingpin relative to the support bracket will, accordingly, vertically adjust the bearing bracket, bearing block, caster arms and caster wheel to provide the desired vertical caster variation.

The components of the adjustable caster in accord with the invention are readily manufactured, and economically produced.

### BRIEF DESCRIPTION OF THE DRAWINGS

The aforementioned objects and advantages of the invention will be appreciated from the following description and accompanying drawings wherein:

FIG. 1 is a perspective view of a caster incorporating the features of the invention,

FIG. 2 is an elevational view of the caster of the invention,

FIG. 3 is a diametrical, sectional, elevational view of the caster as taken through the axis of the kingpin, and

FIG. 4 is a plan view of the support bracket and bearing bracket and kingpin as taken along Section 4-4 of FIG. 2.

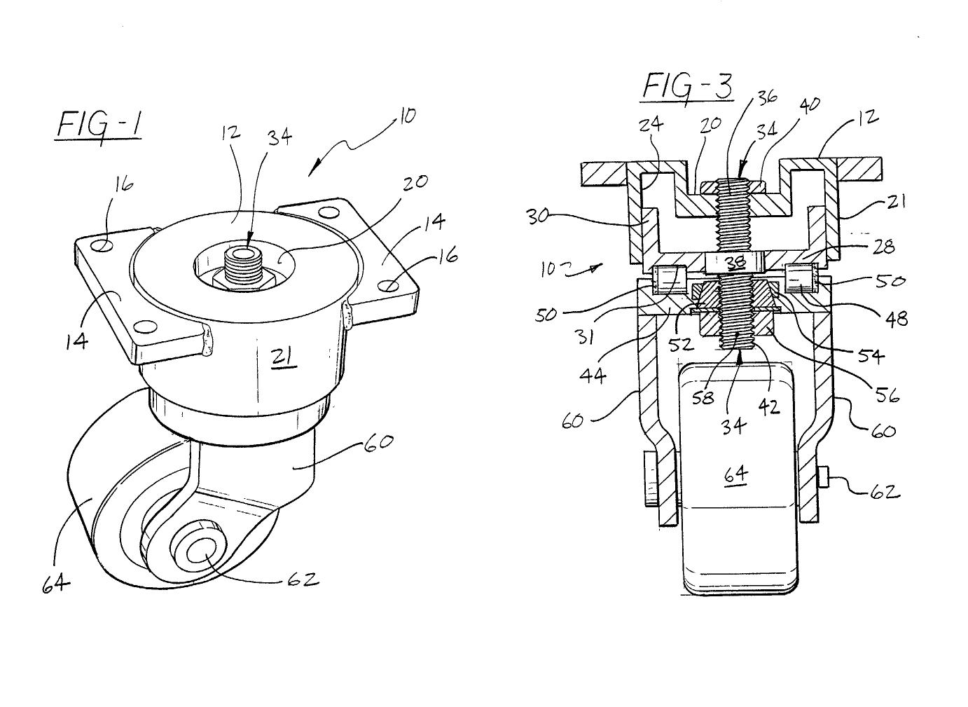

### DESCRIPTION OF THE PREFERRED EMBODIMENT

The assembled caster is represented at 10 and includes a support bracket 12 having ears 14 welded thereto in which holes 16 are defined for attaching the support bracket and caster 10 to the caster supported structure, such as a hand truck, bin, receptacle, or the like. Fasteners such as bolts, not shown, extending through holes 16 firmly attach the caster as desired.

The support bracket 12 centrally includes a threaded opening 18 defined in the center recess 20. The bracket 12 further includes a cylindrical body 21 internally defining the cavity 22 by the cavity's cylindrical side 24, FIG. 4.

A bearing bracket 26 is received within the cavity 22 and includes a base 28 from which extends an annular flanged periphery 30 slidingly engaging the cavity sides 24. On its underside, bearing bracket 26 includes the annular seal recess 31, and a cylindrical opening 32 extends through the bearing bracket base 28.

A kingpin 34 interconnects the support bracket 12 and the bearing bracket 26. In the following description and claims, the terms “upper” and “lower” are used to describe caster components, including the kingpin, and it is to be appreciated that these terms are only used for definitive purposes and are not considered limiting, as it would be possible to install the caster 10 in such a manner that the kingpin 34 would not be vertically oriented in the manner illustrated in the drawings.

The kingpin 34 includes a threaded upper end 36 which threads through the support bracket threaded opening 18, and tightening of the locknut 40 on the kingpin end 36 against the support bracket center 20 will fix the desired relationship and spacing between the support bracket 12 and bearing bracket 26.

The kingpin 34 includes a central cylindrical head 38 which is press fitted or welded into the opening 32 in the bearing bracket such that the kingpin 34 becomes an integral part of the bearing bracket 26.

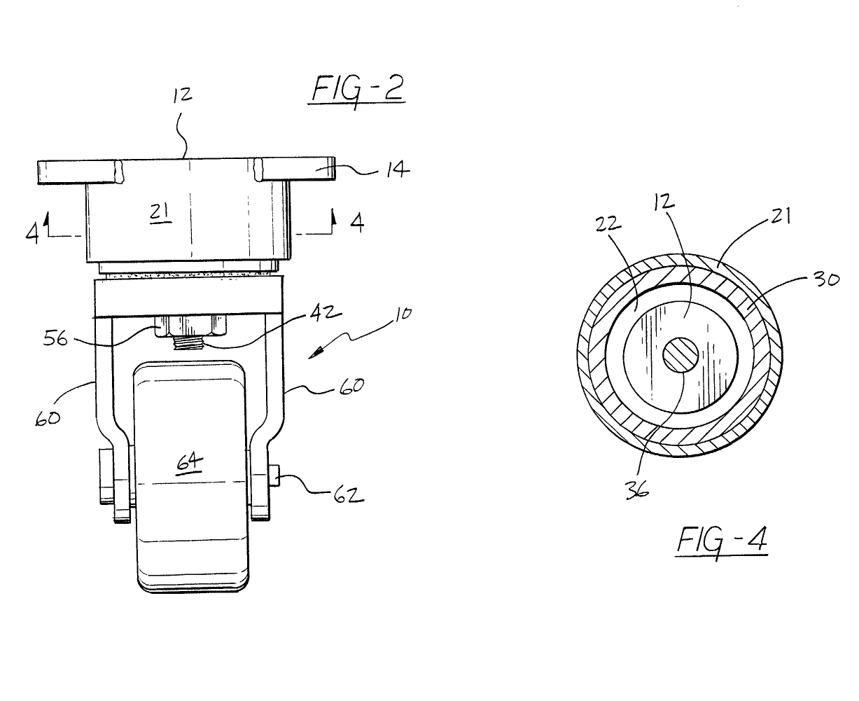

The kingpin lower end 42 extends below the bearing bracket brace 28 and extends through the bearing block 44 having a central opening 46 defined therein for receiving the kingpin lower end 42. An annular thrust washer, FIG. 3, is interposed between the bearing block 44 and the bearing bracket 26 received within the recess 31 defined in the bearing bracket, and a similar recess is defined in the bearing block whereby the thrust washer 48 is capable of transmitting the force through the caster while permitting the lower portion of the caster to rotate relative to the upper portion, as later described. An annular felt seal 50 surrounds the thrust washer 48 and is located within the thrust washer recesses, as shown in FIG. 3.

An alignment bearing between the non-rotatable bearing bracket 26 and the rotatable bearing block 44 consists of a cone bearing 52 affixed to the bearing bracket 26 and a cup bearing 52 attached to the bearing block 44. The bearings 52 and 54 are of annular configuration and the kingpin lower end 42 extends therethrough, and these bearings maintain alignment between the non-rotating and rotating components of the caster.

A slotted nut 56 is threaded upon the kingpin lower end 42, and a pin 58, such as a cotter pin, extends through the kingpin lower end and is received within slots in the nut 56 to prevent rotation of the nut on the kingpin.

Caster arms 60 are attached to the bearing block 44 and extend downwardly in spaced relationship to each other. Axle 62 extending between the arms 60 rotatably supports the caster wheel 64.

As the bearing block 44 and the bearings 52 and 54 rotate relative to the bearing bracket 26, it will be appreciated that the wheel 64 is capable of pivoting about the kingpin axis relative to the support bracket 12. If it is desired to change the vertical dimension of the entire caster 10, as may be necessary due to wear of the wheel 64, the caster 10 is removed from its attached structure, not shown, by removing the fasteners extending through the hole 16, the locknut 40 is loosened, and the lower portion of the caster, including bearing bracket 26 and bearing block 44, are rotated relative to the support bracket. This rotation threads the kingpin upper end 36 within the support bracket opening 18 changing the location of the bearing bracket within the support bracket cavity 22, and thereby adjusting the overall vertical height of the caster 10. The locknut 40 is re-tightened against the support bracket center 20 and the caster 10 is re-mounted.

It will be appreciated from the above description that the caster components described above can be economically formed and the caster easily assembled. It will be appreciated that various modifications to the inventive concepts may be apparent to those skilled in the art without departing from the spirit and scope of the invention.

1. A caster characterized by its ability to be vertically adjusted comprising, in combination, a support bracket adapted to be attached to the device supported by the caster, said bracket having a central vertical axis and a concentric cavity having vertical walls and an open lower end, a bearing bracket received within said cavity slidably engaging said cavity walls, a kingpin mounted in said support bracket supporting said bearing bracket and coaxial with the support bracket axis, adjustment means permitting vertical axial adjustment of said kingpin and said bearing bracket along said axis, and a caster wheel mounted on said bearing bracket vertically movable therewith.

2. A caster as in claim 1, said adjustment means comprising a threaded bore defined in said support bracket and threads defined in said kingpin, said kingpin being threaded into said bore.

3. A caster as in claim 1, a lock nut threaded on said kingpin adapted to engage said support bracket to prevent rotation of said kingpin relative to said support bracket.

4. A caster as in claim 2, said kingpin extending through said bearing bracket and affixing said caster to said bearing bracket.
